(19) United States
(12) Patent Application Publication
(10) Pub. No.: US 2003/0155185 A1
(43) Pub. Date: Aug. 21, 2003

(54) Elevator

(76) Inventors: Masami Nomura, Tokyo (JP); Wim Offerhaus, Veenendaal (NL)

Correspondence Address: LEYDIG VOIT & MAYER, LTD, 700 THIRTEENTH ST. NW, SUITE 300, WASHINGTON, DC, 20005-3960, US

(21) Appl. No.: 10/258,474

(22) PCT Filed: Mar. 8, 2001
(86) PCT No.: PCT/JP01/01825

(51) Int. Cl. B66B 11/08

(52) U.S. Cl. 187/266; 187/254

(57) ABSTRACT

An elevator system which suspends a car 2 and a counterweight 3 through use of a suspension rope (first rope) 6, the rope being passed around and suspended on a (first) turnaround pulley 8 for use with a suspension rope, and the car 2 is driven and caused to ascend or descend by means of a drive rope (second rope) 7 connected to the car 2 or counterweight 3, wherein the drive rope 7 is driven by means of a traction sheave 10 for driving purpose provided at one side of a hoistway 1, and hoisting or lowering action of the car 2 is regulated by means of a brake 17 provided on the turnaround pulley 8 for the suspension rope.

### FIELD OF THE INVENTION

The invention relates to an elevator system, and more particularly, to vertical driving of a rope-type elevator.

### BACKGROUND ART

For a conventional rope-type elevator, there has hitherto been employed an elevator system as shown in FIG.7, wherein a passenger car 2 and a counterweight 3 are usually suspended by a plurality of main ropes 5; the main ropes 5 are hoisted by way of a traction sheave of a hoisting machine 4 having the main ropes 5 therearound, thereby causing the car 2 to ascend or descend; and the car 2 is stopped by means of a brake 17 provided on the hoisting machine 4. However, there has recently been proposed an elevator system which does not use any conventional main ropes, suspends a car and a counterweight through use of a suspension rope, and causes the car to ascend by means of driving either the car or the counterweight or both through use of a drive rope.

Japanese Patent Application Laid-Open No. 151180/1996 describes an elevator system. As shown in FIG. 8, a suspension rope 6 suspends a car 2 and a counterweight 3 through use of a conventional, so-called 2-to-1 rope arrangement. One end of a drive rope 7 is connected to the car 2, and the other end of the same is connected to the counterweight 3. A point of the rope 7 somewhere between the car 2 and the counterweight 3 is passed around a traction sheave of a hoisting machine 4 which is installed in a lower part of a hoistway and equipped with a magnetic brake (brake). The car is caused to ascend or descend by means of lowering either the car or the counterweight through use of the hoisting machine. When an attempt is made to stop the car, the magnetic brake restrains the drive rope by means of the magnetic brake.

Further, Japanese Patent Application Laid-Open No. 156855/1997 or PCT WO 98/29326 describes another elevator system. As shown in FIG. 9, the suspension rope 6 suspends the car 2 and the counterweight 3 by means of a conventional, so-called 1-to-1 rope arrangement. One end of the drive rope 7 is connected to the counterweight 3. The drive rope 7 is routed and passed around the hoisting machine 4, which has a brake and is mounted in an upper or lower part of the hoistway. The rope is routed so as to pass around a turnaround pulley mounted on the end of the hoist way opposite the hoisting machine 4. The rope is connected to the counterweight, thus realizing endless connection. The counterweight is caused to ascend or descend by means of rotation of the hoisting machine, thereby hoisting or lowering the car provided at the other end of the suspension rope. When an attempt is made to stop the car, the hoisting machine, on which the drive rope is passed around, is constrained by means of the brake.

European Patent Application EP0731052 describes another elevator system. As shown in FIG. 10, the suspension rope (main cable) 6 constitutes a conventional, so-called 1-to-1 rope arrangement and suspends the car 2 and the counterweight 3. One end of the drive rope (drive cable) 7 is anchored to an upper part of the hoistway, and the rope is routed downward and is passed around a suspension pulley. The rope is then routed upward and passed around a diverting pulley mounted on upper part of the hoistway. The rope then turns its direction to be routed downward and is passed around a traction sheave of the hoisting machine 4 installed in lower part of the hoistway. The rope is again routed upward and is passed around a diverting pulley provided in a lower portion of the counterweight 3. The rope is again routed downward to the lower part of the hoistway, where the other end of the drive rope is anchored. This elevator system is functionally analogous to that described previously, except for a difference in rope arrangement; that is, the drive rope shown in FIG. 9 is modified to be routed through use of the so-called 2-to-1 rope arrangement.

Japanese Patent Application Laid-Open No. 124259/1997 describes another elevator system. The system employs a rope arrangement identical with those shown in FIGS. 9 and 10 in relation to the layout of the suspension rope 6 and the drive rope 7. However, the hoisting machine 4 having a brake is mounted on the counterweight 3. A turn around pulley is disposed in lieu of the hoisting machine mounted in the hoistway. Accordingly, the hoisting machine 4 mounted on the counterweight 3 takes up the drive rope 7, whereby the counterweight 3 ascends, and the car 2 descends. Stoppage of the car 2 can be implemented by means of restraining the rotation of the hoisting machine 4 through use of the brake.

In any of the previously-described elevator systems, the suspension rope is arranged separately from the drive rope. In order to stop a car, the car is stopped by way of the drive rope and the suspension rope through use of the brake accompanying the hoisting machine. Therefore, the drive and suspension ropes require certainty and reliability, and redundancy with an adequate margin and a high degree of reliability are sought. Whenever an elevator is operated, the drive rope is susceptible to reciprocal friction at the time of transmission of driving force from the traction sheave. Therefore, the life of the drive rope tends to become shorter than that of the suspension rope. When only the drive rope is replaced with a new one, the car or counterweight must be firmly clamped by a guide rail provided in the hoistway so as to prevent occurrence of hoisting,or lowering of the car.

Accordingly, the invention aims at providing an elevator system which can lessen the foregoing requirement (or burden) for the drive rope, diminish the number of drive ropes, and facilitate replacement of the drive rope, by means of placing a suspension rope for suspending a car and a counterweight separately from a drive rope which hoists and lowers the car or counterweight when connected therewith. Moreover, the burden associated with the certainty and reliability of the drive rope can be lessened, and the number of ropes can be reduced. Further, replacement of the drive rope is facilitated, and a degree of freedom in selecting specifications for the drive rope is increased. As a result, space-saving in an elevator system is attained.

### DISCLOSURE OF THE INVENTION

An elevator controller according to the invention is directed toward an elevator in which vertically-movable elements, consisting of a car and a counterweight, are connected to a suspension rope (i.e., a first rope) and in which the suspension rope is passed around a first turn around pulley having a brake, in a position between the respective nodes of the vertically-movable elements. A drive rope (second rope) is passed around a traction sheave for driving purpose and a second turnaround pulley, which are provided separately on respective ends of the hoistway. The drive rope is then connected to the vertically-movable element. The elevator is caused to ascend or descend by means of the drive rope. Here, the vertically-movable elements are caused to ascend or descend by means of rotational control of the traction sheave. In other words, the elevator controller is characterized in that the suspension rope is separated from the drive rope and a brake is provided on the suspension rope.

### BRIEF DESCRIPTION OF THE DRAWINGS

FIG. 1 shows an elevator system according to a first embodiment; that is, a conceptual rendering showing the configuration of an elevator system according to the invention;

FIG. 2 is a fragmentary view showing a turnaround pulley for a suspension rope when viewed along line A-A shown in FIG. 1;

FIG. 3 shows an elevator system according to a second embodiment; that is, a conceptual rendering showing the configuration of an elevator system according to the invention;

FIG. 4 is a fragmentary view showing the surroundings of a turnaround pulley for a drive rope shown in FIG. 3;

FIG. 5 shows an elevator system according to a third embodiment; that is, a conceptual rendering showing the configuration of an elevator system according to the invention;

FIG. 6 is a vertical projection view of the elevator system shown in FIG. 5;

FIG. 7 is a conceptual rendering showing the configuration of a first conventional elevator system;

FIG. 8 is a conceptual rendering showing the configuration of a second conventional elevator system;

FIG. 9 is a conceptual rendering showing the configuration of a third conventional elevator system;

FIG. 10 is a conceptual rendering showing the configuration of a fourth conventional elevator system; and

FIG. 11 is a conceptual rendering showing the configuration of a fifth conventional elevator system.

### BEST MODES FOR IMPLEMENTING THE INVENTION

The present invention provides an elevator system which suspends a car and a counterweight through use of a suspension rope (first rope), the rope being passed around and suspended on a (first) turnaround pulley for use with a suspension rope, and which drives and causes the car to ascend or descend by means of a drive rope (second rope) connected to the car or counterweight, wherein the drive rope is driven by means of a traction sheave for driving purpose provided at one side of a hoistway, and hoisting or lowering action of the car is regulated by means of a brake provided on the turnaround pulley for the suspension rope. In other words, the suspension rope and the drive rope are separated from each other. The pulley provided on the side of the suspension rope is equipped with a brake. Hence, the burden associated with the certainty and reliability of the drive rope can be lessened, thereby enabling relaxation of specifications for the drive rope or a reduction in the number of ropes. Consequently, the configuration of equipment provided on the side of the drive rope can be simplified or down sized. Therefore, the invention is particularly effective for an elevator which involves tight restrictions on the space for installing elevator equipment and which has no particular machine room.

First Embodiment

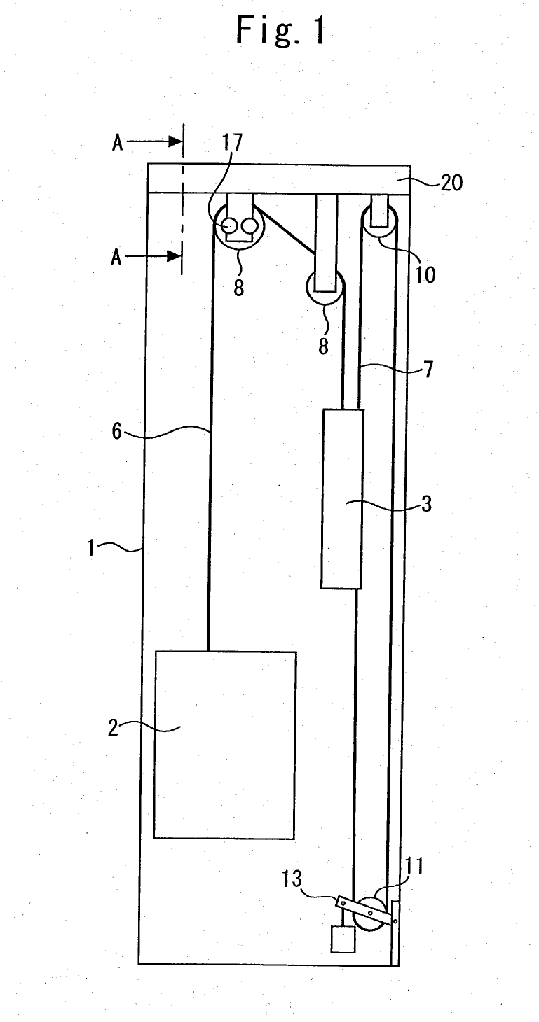

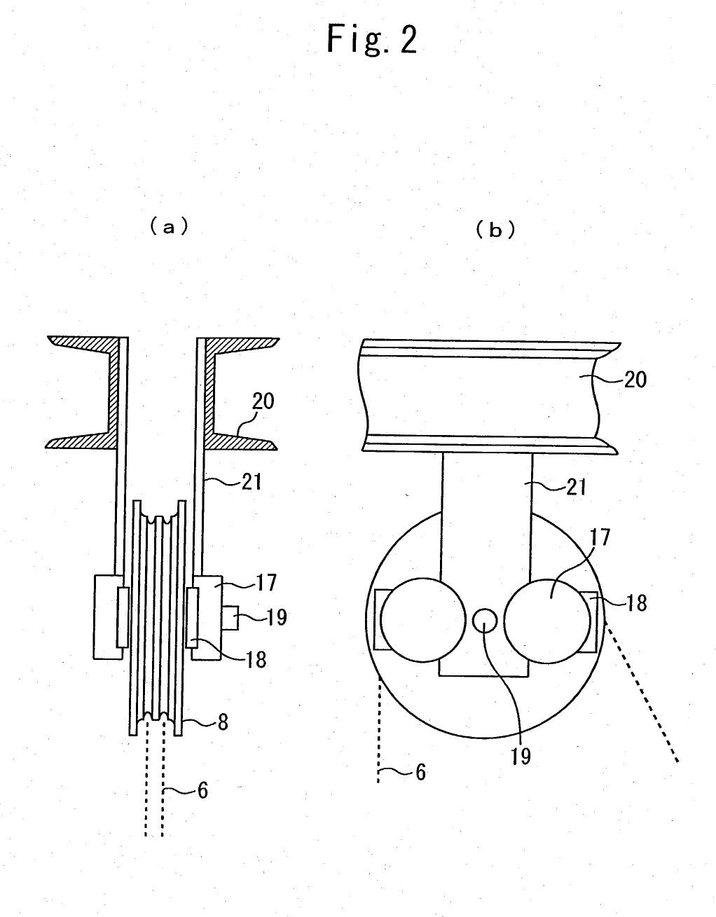

FIG. 1 is a conceptual view showing the configuration of an elevator system according to a first embodiment of the present invention. FIG. 2 shows a turnaround pulley for use with a suspension rope when viewed from line A-A shown in FIG. 1.

Throughout the drawings, reference numeral 1 designates a hoistway in which an elevator system is installed; 2 designates a car which moves vertically through the hoistway 1 while carrying passengers; 6 designates a suspension rope suspending the car 2 at one end thereof; 3 designates a counterweight suspended at the other end of the suspension rope 5; and 8 designates a turnaround pulley for use with a suspension rope, the turnaround pulley 8 being provided at the top of the hoistway and turning the direction of extension of the suspension rope 6. Reference numeral 7 designates a drive rope whose one end is connected to the counterweight 3. The drive rope 7 is routed upward and is passed around a traction sheave 10 for use with a drive rope. Subsequently, the rope is routed downward and is passed around a turnaround pulley 11 for use with a drive rope provided in a lower part of the hoistway 1. The drive rope 7 is again routed upward within the hoistway 1, and the other end of the drive rope is connected to the counterweight 3. Reference numeral 13 designates a tension applicator which applies tension to the drive rope by way of the traction sheave 11. The tension applicator provided in the embodiment is realized by means of attaching a weight to the extremity of a lever. Various methods are available for applying tension to the drive rope, and the method should not be limited to the present embodiment. Reference numeral 20 designates a equipment mount beam provided in an upper part of the hoistway 1. The beam is placed on a structure (not shown) of a building constituting the hoistway 1 or on a structure (not shown) of an elevator, such as a guide rail (which will be described later). Further, the turnaround pulley 8 for use with a suspension rope or the turnaround pulley 10 for use with a drive rope is attached to the beam.

As shown in FIG. 2, reference numeral 17 designates a brake; 18 designates a brake shoe which constitutes the brake 17 and is pressed against the turnaround pulley 8; 19 designates a speed sensor for detecting the number of rotations on the basis of rotations of the turnaround pulley 18, that is, the speed of the vertically-moving car 2; and 21 designates a mount plate used for fastening the turnaround pulley 8 to the equipment mount beam 20. The turnaround pulley 8 has a structure which generates sufficient friction between the pulley and the suspension rope 6 at the time of stop or emergency stop (e.g., a so-called V-shaped groove, an undercut groove, or a fully-wrapped structure).

The elevator system having the foregoing construction according to the invention will now be described.

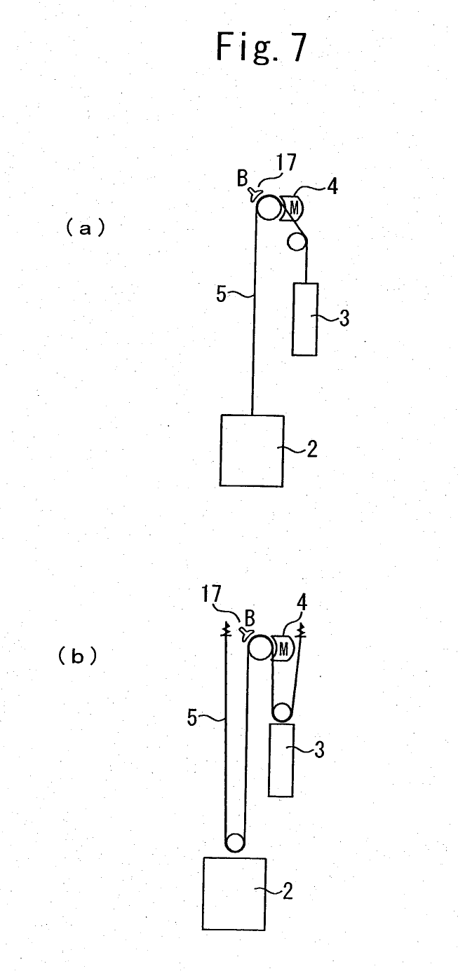

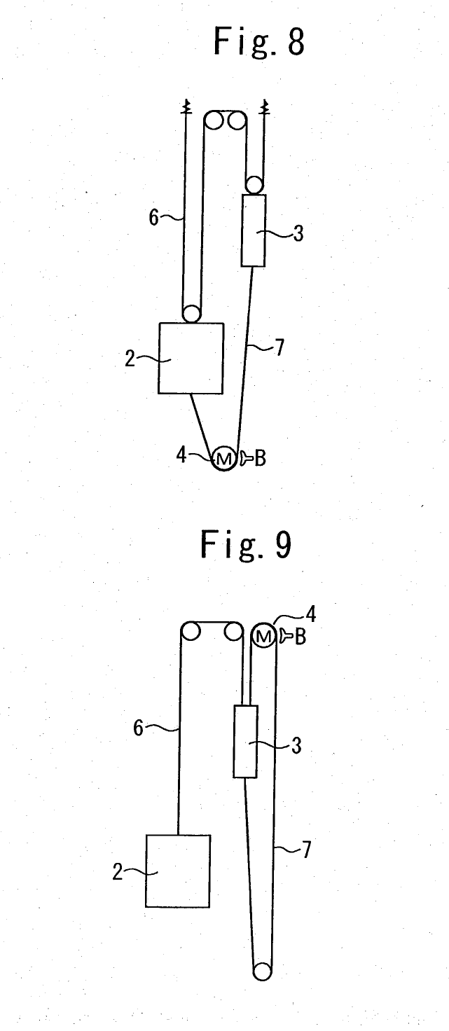

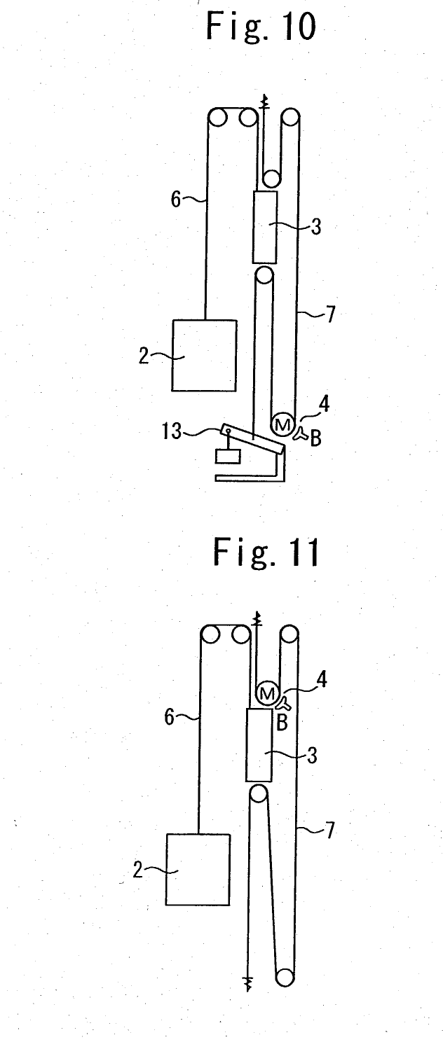

In the elevator, passengers get on or off the car 2 by means of opening an unillustrated door located at an elevator hall and a door (not shown) of the car 2. The car is then caused to ascend or descend to a predetermined destination floor and the door is caused to open and close, thus transporting the passengers. When the car 2 moves up or down, the counterweight 3 suspended at the other end of the suspension rope 6 simultaneously moves in the opposite direction. At the time of travel, the turnaround pulley 8 is disengaged from the brake shoe 18 by means of the brake 17 provided on the turnaround pulley 8, thereby enabling transportation of the suspension rope 6. The traction sheave 10 is rotated by means of driving a hoist motor 4 (see FIG. 7) mounted on the traction sheave 10, thereby actuating the drive rope 7 so as to cause the counterweight 3 to ascend or descend. In other words, the counterweight 3 is caused to ascend or descend by means of imparting torque of the traction sheave 10 to the drive rope 7. As a result, the car 2 connected to the other end of the suspension rope 6 moves vertically. When the car 2 has stopped in conjunction with halt of the hoist motor 4, the brake 17 is activated to lock the turnaround pulley 8, thus holding the car 2 stationary.

In such an elevator system, in the event that, for example, any anomalies have arisen in the drive rope, the brake 17 provided on the turnaround pulley 8 is activated, thereby holding the car without fail. Thus, a reduction in the number of drive ropes or relaxing specifications for ropes can be easily realized. When the drive rope 7 is to be replaced, the drive rope 7 can be removed without involvement of a special step to fasten the car 2 and the counterweight 3, because the car 2 and the counterweight 3 are suspended by the suspension rope by way of the turnaround pulley 8 restrained by the brake 17. Accordingly, replacement of the drive rope 7 obviates special processing for fixing the car and the counterweight. Moreover, the number of ropes to be replaced is low, and working processes become simple. Therefore, the replacement can be implemented more readily than the conventional elevator.

In such an elevator system, the suspension rope 6 and the drive rope 7 are used separately. Particularly, friction stemming from acceleration and deceleration of the elevator between the traction sheave 10 and the rope is burdened on the drive rope 7. The suspension rope 6 has no engagement with the traction sheave 10 and is engaged with the turnaround pulley 8, which involves generation of friction only in the event of emergency stop. The life of the suspension rope 6 can be made longer than in the existing elevator system. Consequently, the number of main ropes 5 can be made less than that employed in the conventional elevator system, by means of reviewing specifications for the ropes.

By means of providing the turnaround pulley 8 with the speed sensor 19, a car speed sensor or a car position sensor can be provided independently of the hoisting machine or the drive rope 7. The movement of the car can be ascertained without taking into consideration slippage arising between the drive rope 7 and the traction sheave; that is, the movement can be ascertained directly without involvement of a drive system. Particularly, even if an anomaly has arisen in a speed control system or drive rope system, the speed or position of the car can be readily detected,independently of the drive system. More specifically, if the car has become uncontrollable for reasons of an anomaly in the drive control or drive rope system while a light load is exerted on the car, the car is accelerated upward by means of a weight difference existing between the car and the counterweight. An emergency car stop (not shown)is usually ineffective for upward movement. For this reason, conventionally the car cannot be stopped until the counterweight reaches a buffer (not shown) provided on the part of the counterweight. According to the invention, the speed of the car can be detected directly and the car can be stopped directly. Hence, a more reliable system can be provided. According to the embodiment, one turnaround pulley 8 is equipped with the speed sensor 19 and the brake 17, thereby readily enabling mechanical or electrical cooperative operation (not shown). Hence, the invention enables immediate countermeasures against an anomalous speed, thereby contributing to an improvement in reliability of the elevator system.

The drive rope 7 and the suspension rope 6 are separated from each other, and the suspension rope 6 can effect stopping operation. Consequently, the burden associated with the functions required for specifications of the drive rope 7 is lessened. Further, replacement of the drive rope becomes easy. Therefore, the specifications for the drive rope 7 can be made different from those for the main rope 5 employed in the conventional elevator system. More specifically, for example, the drive rope 7 is changed from a steel rope to a synthetic fiber rope. Further, there may be employed belts or ropes of various geometries; e.g., one or a plurality of flat ropes or belts formed into a flat plate shape or one or a plurality of V-shaped ropes or belts, formed by coating with synthetic resin, [one or a plurality of ropes] that are superior in transmitting torque to the traction sheave. As a result, the traction sheave 10 or the turnaround pulley 11 can be made smaller by means of reduction in their diameters. Further, material or surface treatment which generates high friction between the sheave and the rope can be readily applied to the elevator. Consequently, there is facilitated layout and design of equipment in an elevator system which has no separate machine room and in which all pieces of equipment are provided within a hoistway.

The present embodiment has described the elevator system such that the traction sheave 10 is placed in the upper part of the hoistway 1 and the turnaround pulley 11 is placed in the lower part of the same. However, the invention is not limited to the embodiment; the same effect can be achieved even when the former is placed in the lower part of the hoistway and the latter is placed in the upper part of the same. Particularly, the traction sheave is integral with a hoisting machine and usually fairly heavy. If the traction sheave is placed in the lower part of the hoistway, the weight of the traction sheave can be utilized as a part of a weight for the tension applicator 13.

The embodiment has been described such that the drive rope 7 is connected to the counterweight 3 and causes the counterweight 3 to ascend or descend. However, it is obvious that the same effect can be achieved even when the drive rope 7 is connected to the car 2 and causes the car 2 to ascend or descend.

In this way, the suspension rope and the drive rope are arranged separately from each other, and the turnaround pulley for use with a suspension rope is equipped with a brake. By means of passing the drive rope around a hoisting machine, use of a rope differing in material and geometry from that used for a conventional elevator becomes feasible. Use of the resultantly-downsized equipment enables implementation of an elevator system which facilitates layout of the equipment.

Second Embodiment

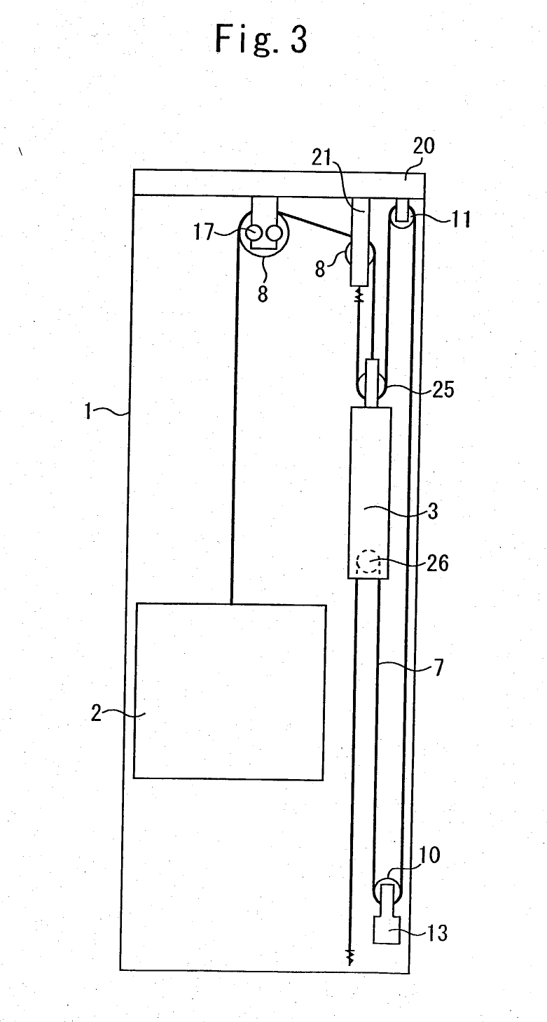

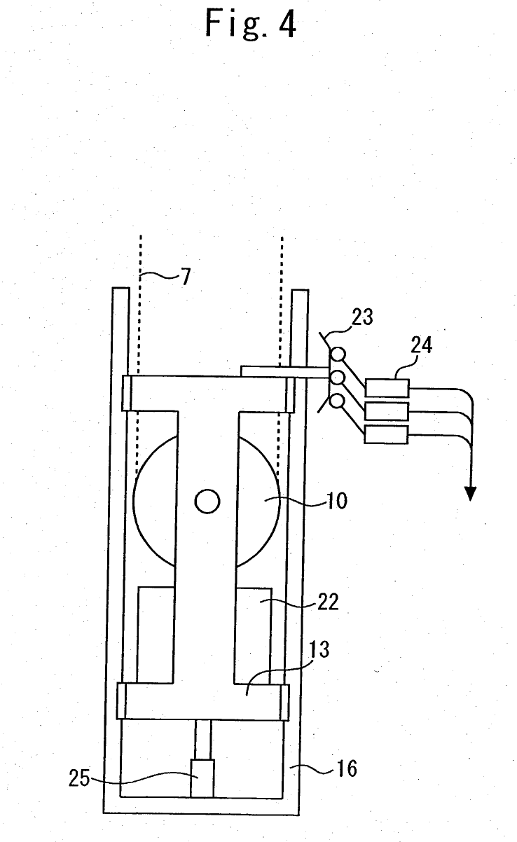

FIGS. 3 and 4 show a second embodiment of the invention. FIG. 3 is a conceptual view showing the configuration of an elevator system according to the present invention. FIG. 4 is a fragmentary view showing the surroundings of a turnaround pulley for a drive rope shown in FIG. Although the first embodiment employs the so-called 1-to-1 rope arrangement for the drive rope 7, a 2-to-1 rope arrangement may be employed in the present embodiment so as to diminish the load or drive torque exerted on the traction sheave 10 or turnaround pulley 11. The tension applicator 13 also has the same function, but the structure thereof has been changed.

In FIGS. 3 and 4, those elements, which are the same as those shown in FIGS. 1 and 2, are labeled with the same reference numerals. Reference numeral 16 designates a guide rail of the tension applicator 13; 22 designates a weight mounted on the tension applicator 13; 23 designates a cam attached to the tension applicator 13; and 24 designates a position switch which is to be engaged with the cam 23 and detects a vertical travel distance of the tension applicator 13 by means of engagement with the cam. Reference numeral 25 designates an upward turnaround pulley attached to an upper part of the counterweight 3; and 26 designates a downward turnaround pulley attached to a lower part of the counterweight 3. Reference numeral 27 designates an oil damper which connects the tension applicator 13 to a fastening section such as the guide rail 16 and damps vertical oscillation of the tension applicator 13.

The elevator system according to the invention, which has the foregoing construction and is shown in the embodiment, will now be described.

The present embodiment is basically identical with that shown in the first embodiment, and explanations will be given primarily of a difference between the embodiments. The drive rope 7 assumes a 2-to-1 rope arrangement, and the tension applicator 13 of the drive rope 7 is equipped with the position switch 24 which is activated in association with vertical movement of the tension applicator 13. The traction sheave 10 is provided in a lower part of the hoistway 1, and the turnaround pulley 11 is provided in an upper part of the hoistway 1.

In the elevator system according to the present embodiment, one end of the drive rope 7 is fastened to, e.g., the equipment mount beam 20 (or the pulley mount plate 21 shown in FIG. 3). The rope 7 is then routed downward and passed around the upward turnaround pulley 25 attached to the upper part of the counterweight 3, thereby suspending the counterweight. The rope is then routed upward and passed around the turnaround rope 11 provided in the upper part of the hoistway. The drive rope 7 is then routed downward and passed around the traction sheave 10 disposed in the lower part of the hoistway. The rope is then routed upward and passed around the downward turn around pulley 26 attached to a lower portion of the counterweight. The rope is routed downward and fastened to the structure (not shown) at the lower part of the hoistway.

The tension applicator 13 of the invention imparts, to the drive rope, the weight of the weight 22, that of the traction sheave 10, and that of a hoisting machine (not shown) which generates driving force in conjunction with the traction sheave, thereby stretching the drive rope. At this time, the tension applicator 13 is arranged so as to be able to move in the stretched direction of the drive rope in accordance with a degree of elongation in the drive rope while being guided by the guide rail 16. In association with movement of the tension applicator 13, the engagement between the cam 23 and the position switch 24 is changed, thereby enabling detection of movement of the tension applicator 13 stemming from elongation of the drive rope 7.

In such an elevator system, when the car 2 is moved upward, the drive rope 7 passed around the downward turnaround pulley 26 of the counterweight 3 is lowered by means of rotation of the traction sheave 10, thus raising the car 2, which operates in association with the suspension rope 6. More specifically, the drive rope 7 is arranged in a so called 2-to-1 rope arrangement. By means of such an arrangement, the load exerted on one drive rope 7 is reduced by one-half. This rope arrangement enables down sizing of a hoisting machine as compared with a 1-to-1 rope arrangement.

Further, the elongation or contraction of the drive rope 7 can be detected in the form of movement of the tension applicator 13, by means of engagement between the cam 23 and the position switch 24. Occurrence of any anomaly or elongation of the drive rope due to secular changes can be readily detected. Hence, at an early stage there can be performed an operation for, e.g., shortening the drive rope, thus enhancing the reliability of the elevator system. When the drive rope 7 is driven for moving the car 2 vertically, considerable vibration arises in the tension applicator 13, thereby affecting riding comfort. However, the oil damper serving as a damping device is provided at a position where the tension applicator 13 is fixed to the guide rail, thereby eliminating vibration and stabilizing riding comfort.

For example, a synthetic fiber rope is elongated greatly when subjected to load or secular changes. However, the elongation can be detected by means of the position switch 24 provided in the tension applicator 13, and a countermeasure against the elongation becomes easy. Hence, the tension applicator is likely to cause vibration in the stretching direction of the rope. However, the oil damper 27 provided in the tension applicator 13; that is, a vibration suppressor, can damp the vibration. In contrast with the conventional main rope 5 or the suspension rope 5 of the embodiment, the drive rope 7 can be subjected to a higher degree of selection than can the main rope or the suspension rope. Particularly, by means of application of a synthetic fiber rope, the rope has no metal contact with the sheave or pulley, thereby enabling realization of an elevator system involving generation of little noise.

Depending on the operating status of the position switch 24; specifically, the degree of elongation of the drive rope 7, transmission of a maintenance request to an un-illustrated maintenance service department or stoppage of operation of the elevator can be performed readily.

Therefore, a rope, for example, a synthetic fiber rope, which elongates to a greater degree than a conventional rope, may be effectively employed for the drive rope.

Third Embodiment

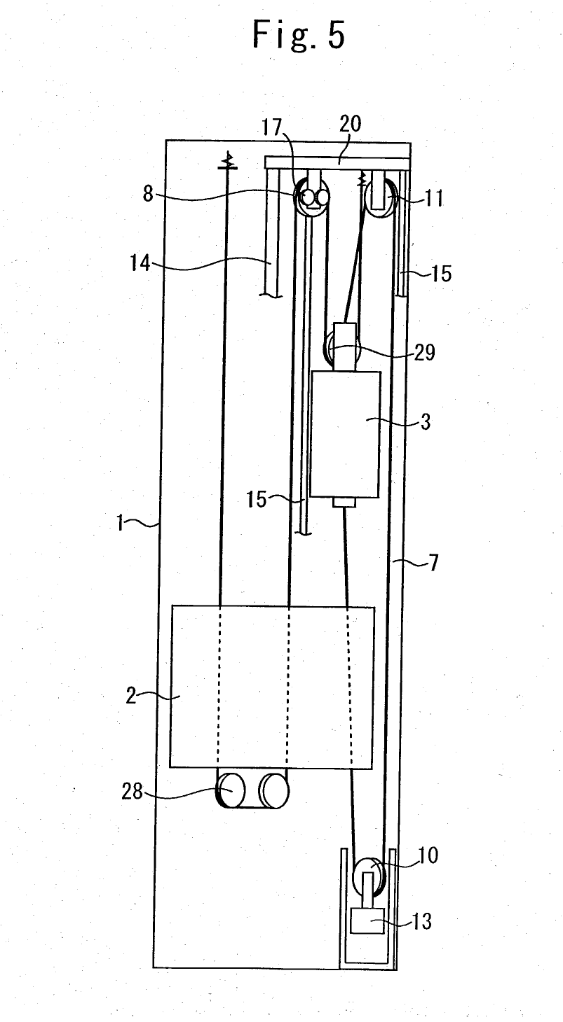

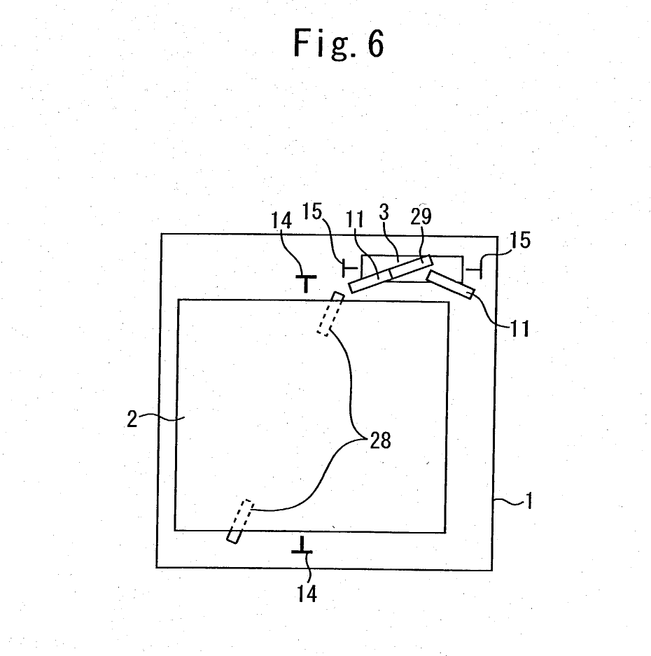

FIGS. 5 and 6 relate to a third embodiment of the present invention. FIG. 5 is a conceptual view showing the configuration of an elevator system according to the invention, and FIG. 6 is a vertical projection view of the elevator system shown in FIG. 5.

In the first and second embodiments, the car and the counterweight are suspended by means of the suspension rope 6 routed in a 1-to-1 rope arrangement. In contrast, the present embodiment employs a 2-to-1 rope arrangement, and the drive rope 7 is routed in a 1-to-1 rope arrangement in the same manner as in the first embodiment. The traction sheave 10 is provided in the lower part of the hoistway, and the turnaround pulley is disposed in the upper part of the hoistway.

In FIGS. 5 and 6, those elements, which are the same as those shown in FIGS. 3 and 4, are labeled with the same reference numerals. Reference numeral 28 designates a turnaround pulley which is provided in a lower portion of the car 2 and is to be used for suspending a car; and 29 designates a turnaround pulley which is provided in an upper portion of a counterweight and is to be used for suspending the counterweight.

There will now be described an elevator system of the invention which has the foregoing configuration and is to be disclosed in the present embodiment.

The invention of the present embodiment is basically same with the inventions described in the previous first and second embodiments. Explanations will be given primarily of a difference between the inventions. The car 2 is equipped with the turnaround pulley 28 for use in suspending a car, and the turnaround pulley 29 for use in suspending a counterweight. The suspension rope 6 is configured in a 2-to-1 rope arrangement.

In the elevator system of the present configuration, the pulley 28 is provided in the lower portion of the car 2. Eventually, the car 2 can move vertically up to the highest location in the hoistway, thereby minimizing the requited substantial height of the hoistway. The turnaround pulley 8 equipped with the brake 17 can reduce the load exerted by the car or counterweight by one-half, by means of the 2-to-1 rope arrangement. Further, the braking force required by the brake can be reduced further. Hence, the brake and the turnaround pulley 8 can be reduced is size further.

Industrial Applicability

An elevator controller according to the invention is characterized in that a suspension rope is separated from a drive rope and in that a brake is provided on the side of the suspension rope. For example, even if any anomaly has arisen in the drive rope, the brake 17 provided on the side of the suspension rope is activated, thereby retaining a car without fail. At the time of replacement of the drive rope 7, the car 2 and the counterweight 3 are stopped by means of the brake 17. Hence, the drive rope 7 can be readily removed without involvement of a necessity for a special operation for fixing the car 2 and the counterweight 3. Accordingly, in accordance with the characteristic required for the suspension rope and the drive rope, optimal rope specifications or an optimum number of ropes can be applied to an elevator system.

In a case where the drive rope is configured in a so-called 2-to-1 rope arrangement, the load exerted on one drive rope 7 is reduced by one-half, and the drive torque of the hoisting machine is also reduced by one-half. Hence, the rope arrangement enables down sizing of the hoisting machine as compared with a 1-to-1 rope arrangement.

As a drive rope, there can be employed ropes of various configurations or geometries differing from a conventional wire rope, such as a synthetic fiber rope, a flat belt, a flat rope, a V-shaped belt, or a V-shaped rope. Driving is optimized, by means of optimizing a friction factor stemming from engagement with a sheave or pulley, using ropes and/or belts in combination so as reduce abrasion or noise, and facilitating stretching of the rope within a hoistway, thus contributing to space savings.

The first turnaround pulley having a brake is equipped with a speed sensor, thereby readily enabling mechanical or electrical cooperative operation. Hence, the invention enables immediate countermeasures against an anomalous speed, thereby contributing to an improvement in reliability of the elevator system.

The traction sheave for driving purpose or the second turnaround pulley is equipped with a tension applicator for applying tension to the drive rope. Since the drive rope can be stretched without involvement of loosening, engagement with the traction sheave becomes reliable. Further, there is provided a sensor for detecting a travel distance of the tension applicator. Hence, elongation of a drive rope due to secular changes or the like can be detected directly. Reliability can be improved by means of finding an anomaly in a rope at an early stage or rationalization of a maintenance operation, such as shortening of a rope.

The tension applicator is also equipped with a damper for suppressing vibrations in itself, thereby inhibiting vibration in the drive rope system. Transmission of vibration from the drive rope to the car is suppressed, thereby contributing to a deterioration in driving comfort.

1. An elevator system having a first rope, the rope suspending at one end a car, being routed in a vertical direction within a hoistway, being passed around a first turnaround pulley, and being routed in a changed direction, and suspending at the other end a counterweight, wherein
a second rope is connected to the counterweight so as to enable vertical movement of the counterweight, routed toward one end of the hoistway, passed around a traction sheave for driving purpose, routed toward the other end of the hoistway, passed around the second turnaround pulley, routed toward the counterweight, and again connected to the counterweight; and wherein the first turnaround pulley is equipped with a brake for regulating rotation thereof.

2. An elevator system having a first rope, the rope suspending at one end a car, being routed in a vertical direction within a hoistway, being passed around a first turnaround pulley, and being routed in a changed direction, and suspending at the other end a counterweight, wherein
a second rope is connected to the car so as to enable vertical movement of the car, routed toward one end of the hoistway, passed around a traction sheave for driving purpose, routed toward the other end of the hoistway, passed around the second turnaround pulley, routed toward the car, and again connected to the car; and wherein the first turnaround pulley is equipped with a brake for regulating rotation thereof.

3. The elevator system according to claim 1 or 2, wherein the second rope is fastened to one end of the hoistway; routed through the hoistway and passed around and connected to a first turnaround pulley of a vertically-movable element, the vertically-movable element being constituted of the car or counterweight; routed through the hoistway in a U-turn direction and passed around the traction sheave for driving purpose; routed toward the other end of the hoistway and passed around a second turnaround pulley; again routed toward the vertically-movable element and passed around and connected to a second turnaround pulley of the vertically-movable element; and routed in a U-turn direction within the hoistway and fastened to the other end of the hoistway.

4. The elevator system according to any one of claims 1 through 3, wherein the first rope, the second rope, the first turnaround pulley, the traction sheave for driving purpose, and the second turnaround pulley are mounted within the hoistway.

5. The elevator system according to claim 1 or 2, wherein the second rope is constituted of synthetic fiber.

6. The elevator system according to claim 1 or 2, wherein the second rope is a flat rope into which one or a plurality of cores are formed with resin into a flat form, or a flat belt.

7. The elevator system according to claim 1 or 2, wherein the second rope is a V-shaped rope into which one or a plurality of cores are formed with resin into the shape of the letter V, or a V-shaped belt.

8. The elevator system according to claim 1 or 2, wherein the first turnaround pulley is equipped with a speed sensor for detecting rotational speed of the first turnaround pulley.

9. The elevator system according to claim 9, wherein, when the speed sensor provided on the first turnaround pulley has detected a speed greater than a predetermined speed, the brake provided in the first turnaround pulley is activated, thereby regulating rotation of the first turnaround pulley.

10. The elevator system according to claim 1 or 2, wherein the traction sheave for driving purpose or the second turnaround pulley is equipped with a tension applicator for applying tension for stretching the second rope.

11. The elevator system according to claim 10, wherein the tension applicator is equipped with a position sensor for detecting movement of the applicator in the direction in which the second rope stretches and contacts.

12. The elevator system according to claim 11, wherein a report is provided upon detection that the tension applicator has been moved a predetermined value or more in the direction in which the second rope stretches and contacts.

13. The elevator system according to claim 11, wherein operation of an elevator is stopped upon detection that the tension applicator has been moved a predetermined value or more in the direction in which the second rope stretches and contacts.

14. The elevator system according to claim 11, wherein the tension applicator is equipped with a damper for suppressing the tension applicator from vibrating in the direction in which the second rope stretches and contacts.
